(19) United States
(12) Patent Application Publication
(10) Pub. No.: US 2025/0056322 A1
(43) Pub. Date: Feb. 13, 2025

(54) DISTRIBUTED LINK FAILURE RESILIENT LOW LATENCY NETWORK ACCESS CONTROL WITH AUTHENTICATION OFFLOAD

(71) Applicant: Juniper Networks, Inc., Sunnyvale, CA (US)

(72) Inventors: Natarajan Manthiramoorthy, Fremont, CA (US); Raja Rao Tadimeti, San Jose, CA (US); Anantha Ravi, San Jose, CA (US); Madhava Rao Cheethirala, San Jose, CA (US); Vinod Peris, Cupertino, CA (US)

(21) Appl. No.: 18/395,023

(22) Filed: Dec. 22, 2023

Related U.S. Application Data
(60) Provisional application No. 63/519,081, filed on Aug. 11, 2023.

(51) Int. Cl. H04W 28/08; H04W 12/069

(52) U.S. Cl. CPC H04W 28/0925; H04W 12/069

(57) ABSTRACT

A network access server (NAS) device on a wireless network at a site is described, the NAS device comprising memory including a policy cache having entries for one or more client devices where each entry includes a last policy action previously identified by a network access control (NAC) system for the respective client device. The NAS device further comprising processing circuitry configured to, upon receipt of an access request for the wireless network from a client device, authenticate the client device. The processing circuitry is configured to, after authentication of the client device, determine whether the client device is included in the policy cache. The processing circuitry is configured to, based on the client device being included in the policy cache, authorize the client device to access the wireless network in accordance with the last policy action for the client device.

This application claims the benefit of U.S. Provisional Patent Application No. 63/519,081, filed 11 Aug. 2023, the entire contents of which is incorporated herein by reference.

### TECHNICAL FIELD

The disclosure relates generally to computer networks and, more specifically, to managing access to computer networks.

### BACKGROUND

Network access server (NAS) devices authenticate client devices (or simply “clients”) and grant them access to a network. Authentication may occur via a handshake exchange between the client device, the NAS device, and an Authentication, Authorization, and Accounting (AAA) server controlling access at the NAS device. NAS devices may include wireless access points (APs), switches, routers, or any network device capable of authenticating and authorizing client devices to access an enterprise network.

For example, commercial premises or sites, such as offices, hospitals, airports, stadiums, or retail outlets, often install complex wireless network systems, including a network of wireless access points (APs), throughout the premises to provide wireless network services to one or more wireless client devices. APs are physical, electronic devices that enable other devices to wirelessly connect to a wired network using various wireless networking protocols and technologies, such as wireless local area networking protocols conforming to one or more of the IEEE 802.11 standards (i.e., “WiFi”), Bluetooth/Bluetooth Low Energy (BLE), mesh networking protocols such as ZigBee or other wireless networking technologies.

Many different types of wireless client devices, such as laptop computers, smartphones, tablets, wearable devices, appliances, and Internet of Things (IoT) devices, incorporate wireless communication technology and may be configured to connect to wireless access points when the device is in range of a compatible AP. In order to gain access to a wireless network, a wireless client device may first need to authenticate to the AP. In that case, the AP acts as a network access server (NAS) device that authenticates client devices and grants them access to the network.

### SUMMARY

A cloud-based network access control (NAC) system provides centralized maintenance of access policies for networks at multiple organization sites. The access policies outline rules and guidelines that govern client device access to networks and/or network resources and define conditions under which network access may be granted or denied to client devices. NAC systems may also handle certificate exchange and authentication with client devices requesting to join the networks via network access server (NAS) devices at the sites. However, cloud-based NAC systems may result in difficulties when a link from the NAS devices at the sites to the cloud-based NAC system goes down or experiences significant latency.

This disclosure describes techniques for the NAS devices themselves to perform certificate-based authentication with the client devices. In addition, this disclosure describes techniques for the NAS devices to cache last access policy actions previously identified by the NAC systems for the client devices, and authorize network access for the client devices based on the cached last access policy actions.

According to the disclosed techniques, a NAS device may quickly authenticate and authorize client devices to access a network even when the link from the NAS device to the NAC system maintaining the access policies for the network is down. A NAS device, as described herein, may include a policy cache that stores the most recent or last policy actions for one or more client devices at a site. The policy cache allows the NAS device to determine most recent or last policy actions for the client devices when connection to a NAC system is unavailable and may provide lower latency client device authorization that does not need to wait for the NAC system to respond. The policy cache at the NAS device may have entries for one or more client devices where each entry includes a last policy action previously identified by the NAC system for the respective client device.

When the NAS device receives an access request for the wireless network from a client device, the NAS device may authenticate the client device based on an exchange of authentication certificates associated with the NAC system and the client device. Alternately or in combination, NAS device may authenticate the client device based on a password authentication. A network management system (NMS) may provision the NAS device with a server certificate and a list of client certificates. The initial authentication may be sufficient to indicate that the client device is known (e.g., the client device is an employee's client device) and thus the NAS device may give the client device a default policy access (which may be greater than a mere guest access to the network).

If the client device is in the policy cache, the NAS device may authorize the client device to access the wireless network in accordance with the last policy action for the client device. Thus, when access to the NAC system is not available (e.g., due to a wide area network (WAN) link between the NAS device and the NAC system being down or the NAC system being down), the NAS device may still authorize the client device to access the wireless network according to the cached policy action.

The described system has a number of technical advantages. A cloud-based NAC system may advantageously maintain the access policies at the cloud-based NAC system instead of at an on-premises device to enable centralized updating, management, and storage of the access policies. The policy cache at a NAS device provides resiliency in the form of “off-line” authorization of client devices to access networks since the NAS device may use a cached policy action even when the NAC system is not accessible. In addition, use of the policy cache at the NAS device to authorize client device access to networks, even when the NAC system is available, may reduce the latency experienced when requesting a policy decision from the NAC system since the NAS device is local at the site rather than remote like the NAC system. Further, local NAS devices that enable certificate-based authentication may result in reduced cloud utilization and associated cost for the NAC system compared to NAS devices that use a cloud-based NAC system to perform certificate-based authentication.

In one example, the disclosure is directed to a NAS device on a wireless network at a site, the NAS device comprising: memory including a policy cache having entries for one or more client devices where each entry includes a last policy action previously identified by a network access control (NAC) system for the respective client device; and processing circuitry configured to: upon receipt of an access request for the wireless network from a client device, authenticate the client device; after authentication of the client device, determine whether the client device is included in the policy cache; and based on the client device being included in the policy cache, authorize the client device to access the wireless network in accordance with the last policy action for the client device.

In another example, the disclosure is directed to a system comprising: a network access control (NAC) system in communication with a plurality of network access server (NAS) devices for wireless networks at one or more sites, the NAC system configured to maintain access policy rules for the wireless networks; and a NAS device of the plurality of NAS devices for a wireless network at a site, the NAS device configured to: upon receipt of an access request for the wireless network from a client device, authenticate the client device; after authentication of the client device, determine whether the client device is included in a policy cache at the NAS device, the policy cache having entries for one or more client devices where each entry includes a last policy action previously identified by the NAC system for the respective client device; and based on the client device being included in the policy cache, authorize the client device to access the wireless network in accordance with the last policy action for the client device.

In yet another example, the disclosure is directed to a method comprising: upon receipt of an access request for a wireless network at a site from a client device, authenticating, by a network access server (NAS) device on the wireless network, the client device based on an exchange of authentication certificates associated with a network access control (NAC) system and the client device; after authentication of the client device, determining, by the NAS device, whether the client device is included in a policy cache at the NAS device, the policy cache having entries for one or more client devices where each entry includes a last policy action previously identified by the NAC system for the respective client device; and based on the client device being included in the policy cache, authorizing, by the NAS device, the client device to access the wireless network in accordance with the last policy action for the client device.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1A is a block diagram of an example network system including a network management system, network access control systems and network access server devices, in accordance with one or more techniques of the disclosure.

FIG. 1B is a block diagram illustrating further example details of the network system of FIG. 1A.

FIG. 2 is a block diagram of an example network access control system, in accordance with one or more techniques of this disclosure.

FIG. 3 is a block diagram of an example network management system, in accordance with one or more techniques of the disclosure.

FIG. 4 is a block diagram of an example network access server, in accordance with one or more techniques of this disclosure.

FIG. 5 is a block diagram of an example edge device, in accordance with one or more techniques of this disclosure.

FIG. 6 is a flowchart illustrating an example policy access process, in accordance with one or more techniques of this disclosure.

FIG. 7 is a flowchart illustrating an example operation for the network access server policy cache, in accordance with one or more techniques of this disclosure.

### DETAILED DESCRIPTION

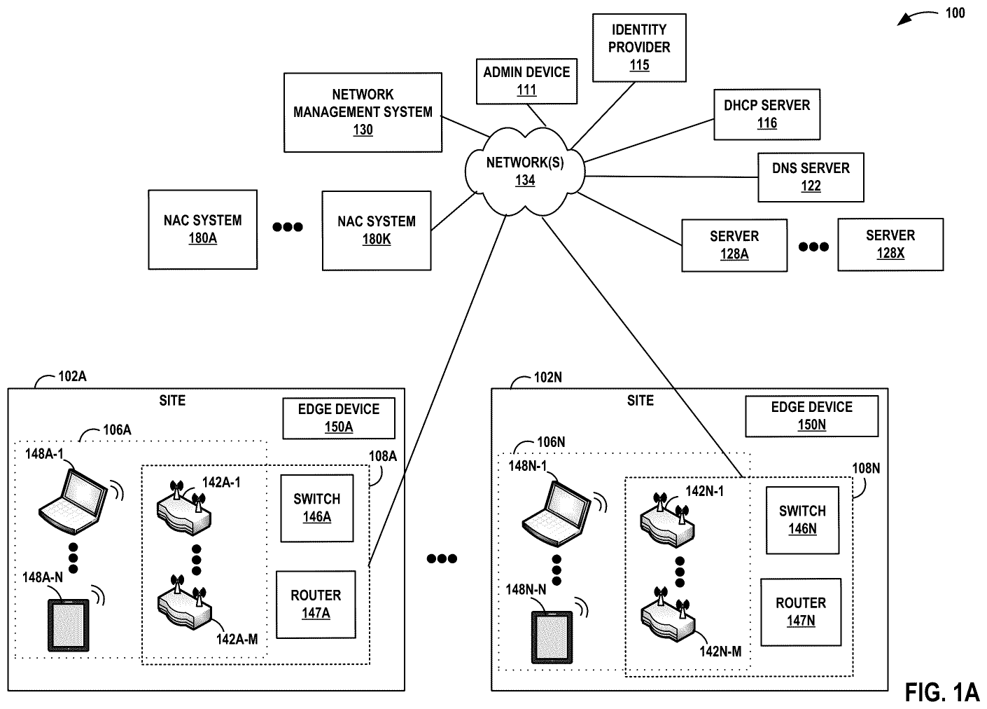

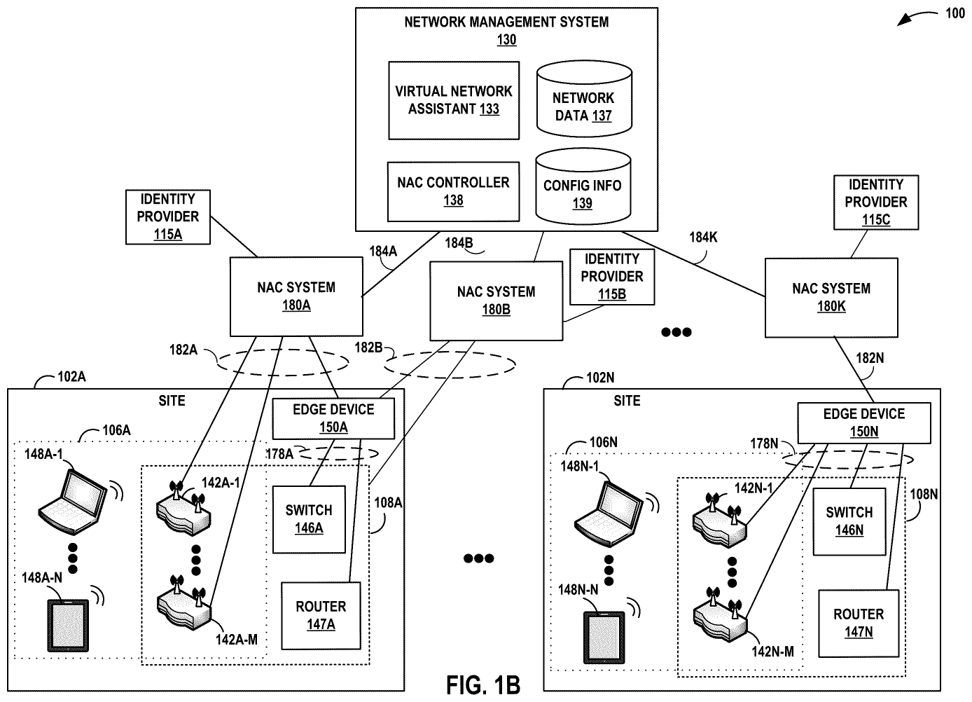

FIG. 1A is a block diagram of an example network system 100 including network access control (NAC) systems 180A-180K (collectively “NAC systems 108”) and network management system (NMS) 130, in accordance with one or more techniques of this disclosure. Example network system 100 includes a plurality of sites 102A-102N (collectively “sites 102”) at which a network service provider manages one or more wireless networks 106A-106N, respectively. Although in FIG. 1A each site 102A-102N is shown as including a single wireless network 106A-106N, respectively, in some examples, each site 102A-102N may include multiple wireless networks, and the disclosure is not limited in this respect.

Each site 102A-102N includes a plurality of network access server (NAS) devices 108A-108N, such as access points (APs) 142, switches 146, and routers 147. NAS devices may include any network infrastructure devices capable of authenticating and authorizing client devices to access an enterprise network. For example, site 102A includes a plurality of APs 142A-1 through 142A-M, a switch 146A, and a router 147A. Similarly, site 102N includes a plurality of APs 142N-1 through 142N-M, a switch 146N, and a router 147N. Each AP 142 may be any type of wireless access point, including, but not limited to, a commercial or enterprise AP, a router, or any other device that is connected to a wired network and capable of providing wireless network access to client devices within the site. In some examples, each of APs 142A-1 through 142A-M at site 102A may be connected to one or both of switch 146A and router 147A. Similarly, each of APs 142N-1 through 142N-M at site 102N may be connected to one or both of switch 146N and router 147N.

Each site 102A-102N also includes a plurality of client devices, otherwise known as user equipment devices (UEs), referred to generally client devices 148, representing various wireless-enabled devices within each site. For example, a plurality of client devices 148A-1 through 148A-K are currently located at site 102A. Similarly, a plurality of client devices 148N-1 through 148N-K are currently located at site 102N. Each client device 148 may be any type of wireless client device, including, but not limited to, a mobile device such as a smart phone, tablet or laptop computer, a personal digital assistant (PDA), a wireless terminal, a smart watch, smart ring, or other wearable device. Client devices 148 may also include wired client-side devices, e.g., IoT devices such as printers, security devices, environmental sensors, or any other device connected to the wired network and configured to communicate over one or more wireless networks 106.

In order to provide wireless network services to client devices 148 and/or communicate over the wireless networks 106, APs 142 and the other wired client-side devices at sites 102 are connected, either directly or indirectly, to one or more network devices (e.g., switches, routers, gateways, or the like) via physical cables, e.g., Ethernet cables. Although illustrated in FIG. 1A as if each site 102 includes a single switch and a single router, in other examples, each site 102 may include more or fewer switches and/or routers. In addition, two or more switches at a site may be connected to each other and/or connected to two or more routers, e.g., via a mesh or partial mesh topology in a hub-and-spoke architecture. In some examples, interconnected switches 146 and routers 147 comprise wired local area networks (LANs) at sites 102 hosting wireless networks 106.

Example network system 100 also includes various networking components for providing networking services within the wired network including, as examples, NAC systems 180A-180K including or providing access to Authentication, Authorization and Accounting (AAA) servers for authenticating users and/or client devices 148, a Dynamic Host Configuration Protocol (DHCP) server 116 for dynamically assigning network addresses (e.g., IP addresses) to client devices 148 upon authentication, a Domain Name System (DNS) server 122 for resolving domain names into network addresses, a plurality of servers 128A-128X (collectively “servers 128”) (e.g., web servers, databases servers, file servers and the like), and NMS 130. As shown in FIG. 1A, the various devices and systems of network 100 are coupled together via one or more network(s) 134, e.g., the Internet and/or an enterprise intranet.

In the example of FIG. 1A, NMS 130 is a cloud-based computing platform that manages wireless networks 106A-106N at one or more of sites 102A-102N. As further described herein, NMS 130 provides an integrated suite of management tools and implements various techniques of this disclosure. In general, NMS 130 may provide a cloud-based platform for wireless network data acquisition, monitoring, activity logging, reporting, predictive analytics, network anomaly identification, and alert generation. In some examples, NMS 130 outputs notifications, such as alerts, alarms, graphical indicators on dashboards, log messages, text/SMS messages, email messages, and the like, and/or recommendations regarding wireless network issues to a site or network administrator (“admin”) interacting with and/or operating admin device 111. Additionally, in some examples, NMS 130 operates in response to configuration input received from the administrator interacting with and/or operating admin device 111.

The administrator and admin device 111 may comprise IT personnel and an administrator computing device associated with one or more of sites 102. Admin device 111 may be implemented as any suitable device for presenting output and/or accepting user input. For instance, admin device 111 may include a display. Admin device 111 may be a computing system, such as a mobile or non-mobile computing device operated by a user and/or by the administrator. Admin device 111 may, for example, represent a workstation, a laptop or notebook computer, a desktop computer, a tablet computer, or any other computing device that may be operated by a user and/or present a user interface in accordance with one or more aspects of the present disclosure. Admin device 111 may be physically separate from and/or in a different location than NMS 130 such that admin device 111 may communicate with NMS 130 via network 134 or other means of communication.

In some examples, one or more of NAS devices 108, e.g., APs 142, switches 146, and routers 147, may connect to edge devices 150A-150N via physical cables, e.g., Ethernet cables. Edge devices 150 comprise cloud-managed, wireless local area network (LAN) controllers. Each of edge devices 150 may comprise an on-premises device at a site 102 that is in communication with NMS 130 to extend certain microservices from NMS 130 to the on-premises NAS devices 108 while using NMS 130 and its distributed software architecture for scalable and resilient operations, management, troubleshooting, and analytics.

Each one of the network devices of network system 100, e.g., NAC systems 180, servers 116, 122 and/or 128, APs 142, switches 146, routers 147, client devices 148, edge devices 150, and any other servers or devices attached to or forming part of network system 100, may include a system log or an error log module wherein each one of these network devices records the status of the network device including normal operational status and error conditions. Throughout this disclosure, one or more of the network devices of network system 100, e.g., servers 116, 122 and/or 128, APs 142, switches 146, routers 147, and client devices 148, may be considered “third-party” network devices when owned by and/or associated with a different entity than NMS 130 such that NMS 130 does not directly receive, collect, or otherwise have access to the recorded status and other data of the third-party network devices. In some examples, edge devices 150 may provide a proxy through which the recorded status and other data of the third-party network devices may be reported to NMS 130.

In the example of FIG. 1A, each of NAC systems 180 comprises a cloud-based network access control service at multiple, geographically distributed points of presence. Typically, network access control functionality is offered by on-premises appliances that are limited by processing power and memory as well as maintenance and upgrade issues. Offering cloud-based network access control services avoids the limitations and improves network administration. As described in more detail below, centralized, cloud-based deployment of network access control functionality may, however, introduce issues with latency and connectivity failures that may block client devices from network access.

NAC systems 180 provide multiple points of presence or NAC clouds at several geographic regions. NMS 130 is configured to manage NAC configuration, including access policies for enterprise networks, and push the appropriate NAC configuration data or files to the respective NAC clouds 180A-180K. In this way, NAC systems 180 provide the same benefits as a centralized, cloud-based network access control service with lower latency and high availability.

Client devices 148 may include multiple different categories of devices with respect to a given enterprise, such as trusted enterprise devices, bring-your-own-device (BYOD) devices, IoT devices, and guest devices. NAC system 180 may be configured to subject each of the different categories of devices to different types of tracking, different types of authorization, and different levels of access privileges. In some examples, after a client device gains access to the enterprise network, NAC systems 180 may monitor activities of the client device to identify security concerns and, in response, re-assign the client device to a quarantine VLAN or another less privileged VLAN to restrict access of the client device.

NMS 130 is configured to operate according to an artificial intelligence/machine-learning-based computing platform providing comprehensive automation, insight, and assurance (WiFi Assurance, Wired Assurance and WAN assurance) spanning from “client,” e.g., client devices 148 connected to wireless networks 106 and wired local area networks (LANs) at sites 102 to “cloud,” e.g., cloud-based application services that may be hosted by computing resources within data centers.

NMS 130 provides an integrated suite of management tools and implements various techniques of this disclosure. In general, NMS 130 may provide a cloud-based platform for wireless network data acquisition, monitoring, activity logging, reporting, predictive analytics, network anomaly identification, and alert generation. For example, NMS 130 may be configured to proactively monitor and adaptively configure network 100 so as to provide self-driving capabilities.

In some examples, AI-driven NMS 130 also provides configuration management, monitoring and automated oversight of software defined wide-area networks (SD-WANs), which operate as an intermediate network communicatively coupling wireless networks 106 and wired LANs at sites 102 to data centers and application services. In general, SD-WANs provide seamless, secure, traffic-engineered connectivity between “spoke” routers (e.g., routers 147) of the wired LANs hosting wireless networks 106, such as branch or campus enterprise networks, to “hub” routers further up the cloud stack toward the cloud-based application services. SD-WANs often operate and manage an overlay network on an underlying physical Wide-Area Network (WAN), which provides connectivity to geographically separate customer networks. In other words, SD-WANs extend Software-Defined Networking (SDN) capabilities to a WAN and allow network(s) to decouple underlying physical network infrastructure from virtualized network infrastructure and applications such that the networks may be configured and managed in a flexible and scalable manner.

In some examples, AI-driven NMS 130 may enable intent-based configuration and management of network system 100, including enabling construction, presentation, and execution of intent-driven workflows for configuring and managing devices associated with wireless networks 106, wired LAN networks, and/or SD-WANs. For example, NMS 130 may enable declarative requirements that express a desired configuration of network components without specifying an exact native device configuration and control flow. By utilizing declarative requirements, NMS 130 may specify goals that should be accomplished rather than what specifying how the goals should be accomplished. Declarative requirements may be contrasted with imperative instructions that describe the exact device configuration syntax and control flow to achieve the configuration. By utilizing declarative requirements rather than imperative instructions, a user and/or user system may relieve the burden of determining the exact device configurations required to achieve a desired result of the user/system. For example, it is often difficult and burdensome to specify and manage exact imperative instructions to configure each device of a network when various different types of devices from different vendors are utilized. Networks 134 may include a variety of types and kinds of devices of the network that may dynamically change as new devices are added and device failures occur. A network administrator, such as the administrator operating admin device 111 may struggle to manage various different types of devices from different vendors with different configuration protocols, syntax, and software versions, and may find it challenging to configure a cohesive network of devices. Thus, by only requiring a user/system to specify declarative requirements that specify a desired result applicable across various different types of devices, NMS 130 may more efficiently manage and configure the network devices. Further example details and techniques of an intent-based network management system are described in U.S. Pat. No. 10,756,983, entitled “Intent-based Analytics,” and U.S. Pat. No. 10,992,543, entitled “Automatically generating an intent-based network model of an existing computer network,” each of which is hereby incorporated by reference.

In some examples, the above described techniques may be performed by any other computing device(s), system(s), and/or server(s), and that the disclosure is not limited in this respect. For example, one or more computing device(s) configured to execute the functionality of the techniques of this disclosure may reside in a dedicated server or be included in any other server in addition to or other than NAC systems 180 or NMS 130, or may be distributed throughout network 100, and may or may not form a part of NAC systems 180 or NMS 130

NAC systems 180 may maintain access policies for NAS devices 108 at a plurality of sites 102A-102N for multiple organizations, and networks. NAC systems 180 may provide client devices 148 with the appropriate access policies based on their identities, e.g., by assigning the client devices to certain virtual local area networks (VLANs), applying certain access control lists (ACLs), directing the client devices to certain registration portals, or the like. NAC systems 180 may also identify client devices 148 by analyzing network behavior of the client devices, referred to as fingerprinting. NAC systems 180 may perform identification of client devices based on media access control (MAC) addresses, DHCP options used to request IP addresses, link layer discovery protocol (LLDP) packets, user agent information, and/or device type and operating system information.

In accordance with one or more techniques of this disclosure, NAS devices 108 are configured to perform authentication of client devices 148. Examples of authentication may include certificate authentication and password authentication. After NAS device 108A authenticates client device 148, NAS device 108A may use a policy cache to authorize client device 148A-1 to access wireless network 106A in accordance with an access policy action for client device 148A-1.

For certificate authentication rather than having NAC systems 180 handle certificate exchange and authentication for client devices 148 at the sites 102, NAS devices 108 are configured to perform certificate-based authentication of client devices 148. When one of NAS devices 108A, for example, receives an access request for the wireless network from a client device 148A-1, NAS device 108A may authenticate client device 148A-1 based on an exchange of authentication certificates associated with one of NAC systems 180 and client device 148A-1.

In one authentication process, once client device 148A-1 has contacted NAS device 108A, NAS device 108A may send an Extensible Authentication Protocol (EAP) identification (ID) request to client device 148A-1. Client device 148 may respond with an EAP ID response to NAS device 108A. Extensible Authentication Protocol (EAP) is an authentication framework used in computer networks and communication protocols. It provides a method for secure and flexible authentication between client devices and network services, such as Wi-Fi networks, virtual private networks (VPNs), and 802.1X port-based network access control.

NAS devices 108 may store certificates in proxy for NAC system 180. NMS 130 may provision NAS device 108A with server certificates associated with NAC systems 180 and a list of client certificates. After client device 148A-1 sends an EAP ID response to NAS device 108, the NAS device 108A may provide the server certificate to client device 148A-1.

Client device 148A-1 may then validate the server certificate. Client device 148A-1 may examine the server certificate and checks the server certificate's digital signature, expiration date, and other attributes. The server certificate may contain a chain of trust, including intermediate certificates and a root certificate. Client device 148A-1 may perform various checks to validate the certificate's integrity and authenticity, including verifying the digital signature, ensuring the certificate has not expired, and checking the issuer's identity.

If client device 148A-1 successfully validates the server certificate, client device 148A-1 provides the client certificate to NAS device 108A. NAS device 108A may store a list of client certificates to validate client certificates as provisioned by NMS 130. NAS device 108A may then validate the client certificate using the list of client certificates. NAS device 108A may examine the client certificate and check the client certificate's digital signature, expiration date, and other attributes. NAS device 108A may receive include a client certificate that contains a chain of trust, including intermediate certificates and a root certificate. NAS device 108A may perform various checks to validate the certificate's integrity and authenticity, including verifying the digital signature, ensuring the certificate has not expired, and checking the issuer's identity. In one example, NAS device 108A need not check whether the client certificate was revoked. NAS device 108A may rely on NAC system 180 or edge device 150 to maintain and check a certificate revocation list (CRL) to determine the status of the client certificate of client device 148A-1. NAS device may check with edge device 150 and/or NAC system 180 to determine if the client device 148A-1 has had its client certificate revoked.

For password authentication, NAS device 108A may cache username and password pairs locally and then authenticate client device 148A-1 using the password. Client device 148A-1 may provide username and password pair to NAS device 108A. NAS device 108A may then check to ensure that the correct username and password pair was provided by client device 148A-1. NAS device 108A may securely store passwords using a hash process that converts passwords into a hash value using a hashing algorithm (such as bcrypt, SHA, etc.). NAS device 108A may use a hashing algorithm that is not reversable so the hash value cannot be used to recreate the password. NMS 130 may provision NAS device 108A with the username and password hashes for client devices.

NAC system 180 may maintain access policies. Network access policies help maintain the security and integrity of networks. Network access policies may outline the rules and guidelines that govern client device access to network resources and define the conditions under which access is granted or denied.

NAC system 180 may do an identity provider lookup at identity providers 115A-C (collectively “identity providers 115”) to get identity information for client device 148. NAC system 180 may use the identities obtained from identity providers 115 to evaluate policy rules for access policies. Identity providers 115 may be a system or service responsible for managing user identities, authenticating users, and providing authorization information to other systems or services. Examples of identity providers include Microsoft Azure Active Directory and Google Cloud Identity Platform. Identity Providers 115 may act as a central authority for identity management within an organization or across multiple organizations.

NAC system 180 may use the access policies to determine client devices that should have access to the network resources according to groups such as employees, contractors, or specific user groups. NAC system 180 may implement access policies using Access Control Lists (ACLs) which are rules that control inbound and outbound traffic based on source and destination IP addresses, port numbers, and protocols. NAC system 180 may implement access policies that divide the network into different segments or virtual local area networks (VLANs) to control access between different parts of the network to implement firewall rules and VLAN configurations to restrict communication between segments and limit access to sensitive resources.

NAS devices 108 may cache the last policy action for client device 148 previously identified by NAC system 180 in a policy cache to provide a most recent policy action for client device 148 even when the link from the NAS device 108 to NAC system 180 is down. The last policy actions in the policy cache of NAS device 108 may indicate levels of access based on job functions and requirements, such as access to VLANs or network partitions. NAS devices 108 may check the last access policy action in the policy cache for client device 148 and provide access to the client device 148 based on the cached last policy action.

When NAS device 108 receives updated policy actions from NAC system 180, NAS device 108 may update the cached policy action for the client device 148. The policy cache allows NAS device 108 to determine a most recent or last policy action for the client devices when connection to a network access control (NAC) system is unavailable. The policy cache may also provide a fast access authorization that does not need to wait for NAC system 180 to respond. The policy cache at NAS device 108 may have entries for one or more client devices 148 where each entry includes a last policy action previously identified by the NAC system for the respective client device 148. When access to NAC system 180 is not available (such due to a wide area network (WAN) link between the NAS device 108 and the NAC system 180 being down), NAS device 108 may still authorize client device 148 to access the wireless network according to the cached policy action if the client device 148 is in the policy cache.

Even when NAC system 180 is available, NAS device 108 may authorize the client device 148 to access the wireless network according to the cached policy action while the NAS device 108 checks with the NAC system 180 for updates or modifications to the access policy. In this way, NAS device 108 reduces the connection latency for client device 148. If the access policy has changed since the last stored policy action for the client device in policy cache of NAS device 108, NAS device 108 may re-authenticate and authorize client device 148 to access the wireless network according to the updated access policy and update the policy cache.

NAS device 108 may update the policy cache whenever NAS device 108 receives new policy actions for the client devices from NAC system 180. NAC system 180 may also maintain a certificate revocation list (CRL) and indicate to NMS 130 when a client device has a revoked certificate. NMS 130 may instruct all NAS devices associated with the client device with the revoked certificate to clear the policy cache of such client devices. NMS 130 may also push updated client certificates to the NAS devices to enable the certificate-based authentication to occur at NAS device 108. NMS 130 may also push username and password hashes to the NAs device 108 to enable the password-based authentication to occur at NAS device 108.

NAS device 108 may synchronize the policy cache with policy caches of one or more other NAS devices at the site. NAS device 108 may maintain a list of neighbor NAS devices and inform the neighbor NAS devices whenever NAS device 108 updates the policy cache so that the neighbor NAS devices may update their policy caches accordingly. NAS device 108 may synchronize the policy caches at neighboring NAS devices and enable fast roaming of client devices among neighboring NAS devices. Otherwise, client device 148 may encounter a lag at a second NAS device after already authenticating to a first NAS device.

The techniques of this disclosure provide one or more technical advantages and practical applications. A cloud-based NAC system 180 that interacts with NAS devices 108 using policy caches may offer a number of advantages over a traditional, on-premises NAC solution including centralized access policy management, resilience, reduced latency, and reduced cloud utilization. NAC systems 180 may store access policies in the cloud instead of on an on-premises devices to allow for centralized updating, management, and storage of the access policies. A policy cache at NAS device 108 allows access to the policies maintained by NAC system 180, even if NAC system 180 is unavailable. The policy cache at NAS device 108 may reduce the latency to obtain a policy decision, since NAS device 108 is local to the site rather than remote like the NAC system 180. NAS devices 108 that perform certificate authentication or password authentication may reduce cloud utilization and associated cost for NAC system 180 compared to NAS devices 108 that use NAC system 180 to do certificate checking. Such centralized access policy management may save time and resources since administrators no longer need to manage access policies on multiple on-premises devices.

FIG. 1B is a block diagram illustrating further example details of the network system of FIG. 1A. In this example, FIG. 1B illustrates logical connections 178A-178N, 182A-182N, and 184A-184K, between NAS devices 108 at sites 102, NAC systems 180, and NMS 130. In addition, FIG. 1B illustrates NMS 130 configured to operate according to an AI-based computing platform to provide configuration and management of one or more of NAC systems 180 and NAS devices 108 at sites 102 via the logical connections.

In operation, NMS 130 observes, collects and/or receives network data 137, which may take the form of data extracted from messages, counters, and statistics, for example, from one or more of APs 142, switches 146, routers 147, edge devices 150, NAC systems 180, and/or other nodes within network 134. NMS 130 provides a management plane for network 100, including management of enterprise-specific configuration information 139 for one or more of NAS devices 108 at sites 102 and NAC systems 180. Each of the one or more NAS devices 108 and each of NAC systems 180 may have a secure connection with NMS 130, e.g., a RadSec (RADIUS over Transport Layer Security (TLS)) tunnel or another encrypted tunnel. In accordance with one or more techniques of this disclosure, NAS devices 108 may not need to implement a RADIUS stack when the NAS device 108 implements the authentication locally. Each of the NAS devices 108 and NAC systems 180 may download the appropriate enterprise-specific configuration information 139 from NMS 130 and enforce the configuration. In some scenarios, one or more of NAS devices 108 may be a third-party device or otherwise not support establishment of a secure connection directly with NMS 130. In these scenarios, edge devices 150 may provide proxies through which NAS devices 108 may connect to NMS 130.

In accordance with one specific implementation, a computing device is part of NMS 130. In accordance with other implementations, NMS 130 may comprise one or more computing devices, dedicated servers, virtual machines, containers, services, or other forms of environments for performing the techniques described herein. Similarly, computational resources and components implementing VNA 133 may be part of NMS 130, may execute on other servers or execution environments, or may be distributed to nodes within network 134 (e.g., routers, switches, controllers, gateways, and the like).

In some examples, NMS 130 monitors network data 137, e.g., one or more service level expectation (SLE) metrics, received from each site 102A-102N, and manages network resources, such as the one or more of APs 142, switches 146, routers 147, and edge devices 150 at each site, to deliver a high-quality wireless experience to end users, IoT devices and clients at the site. In other examples, NMS 130 monitors network data 137 received from NAC systems 180 and manages enterprise-specific configuration information 139 for NAC systems 180 to enable unconstrained network access control services for client devices 148 at sites 102 with low latency and high availability.

As illustrated in FIG. 1B, NMS 130 may include a virtual network assistant (VNA) 133 that implements an event processing platform for providing real-time insights and simplified troubleshooting for IT operations, and that automatically takes corrective action or provides recommendations to proactively address network issues. VNA 133 may, for example, include an event processing platform configured to process hundreds or thousands of concurrent streams of network data 137 from sensors and/or agents associated with APs 142, switches 146, routers 147, edge devices 150, NAC systems 180, and/or other nodes within network 134. For example, VNA 133 of NMS 130 may include an underlying analytics and network error identification engine and alerting system in accordance with various examples described herein. The underlying analytics engine of VNA 133 may apply historical data and models to the inbound event streams to compute assertions, such as identified anomalies or predicted occurrences of events constituting network error conditions. Further, VNA 133 may provide real-time alerting and reporting to notify a site or network administrator via admin device 111 of any predicted events, anomalies, trends, and may perform root cause analysis and automated or assisted error remediation. In some examples, VNA 133 of NMS 130 may apply machine learning techniques to identify the root cause of error conditions detected or predicted from the streams of network data 137. If the root cause may be automatically resolved, VNA 133 may invoke one or more corrective actions to correct the root cause of the error condition, thus automatically improving the underlying SLE metrics and also automatically improving the user experience.

Further example details of operations implemented by the VNA 133 of NMS 130 are described in U.S. Pat. No. 9,832,082, issued Nov. 28, 2017, and entitled “Monitoring Wireless Access Point Events,” U.S. Publication No. US 2021/0306201, published Sep. 30, 2021, and entitled “Network System Fault Resolution Using a Machine Learning Model,” U.S. Pat. No. 10,985,969, issued Apr. 20, 2021, and entitled “Systems and Methods for a Virtual Network Assistant,” U.S. Pat. No. 10,958,585, issued Mar. 23, 2021, and entitled “Methods and Apparatus for Facilitating Fault Detection and/or Predictive Fault Detection,” U.S. Pat. No. 10,958,537, issued Mar. 23, 2021, and entitled “Method for Spatio-Temporal Modeling,” and U.S. Pat. No. 10,862,742, issued Dec. 8, 2020, and entitled “Method for Conveying AP Error Codes Over BLE Advertisements,” all of which are incorporated herein by reference in their entirety.

In addition, as illustrated in FIG. 1B, NMS 130 may include a NAC controller 138 that implements a NAC configuration platform that provides a user interface to create and assign access policies for client devices 148 of wireless networks 106, and provides the appropriate enterprise-specific configuration information 139 to the respective NAC clouds 180A-180K. NMS 130 may have a secure connection 184A-184K, e.g., a RadSec tunnel or another encrypted tunnel, with each of NAC systems 180A-180K, respectively. Through secure connections 184, NAC controller 138 may receive network data 137, e.g., NAC event data, from each of NAC systems 180 and each of NAC systems 180 may download the appropriate configuration information 139 from NMS 130. In some examples, NAC controller 138 may log or map which enterprise networks are served by which of NAC systems 180. In addition, NAC controller 138 may monitor NAC systems 180 to identify failures of primary NAC systems and manage failovers to standby NAC systems.

In the example illustrated in FIG. 1B, each of NAS devices 108, directly or indirectly, has a connection with at least one of NAC systems 180. For example, each of APs 142A within site 120A has a connection 182A to NAC system 180A. As discussed below, when NAS devices 108 implement certificate authentication, NAS devices 108 do not need to implement the RADIUS or RadSec (a protocol for transporting RADIUS datagrams over TCP and TLS). Instead, NAS devices 108 may communicate using a simpler protocol such as Hypertext Transfer Protocol Secure (HTTPS) rather than use a RADIUS tunnel to one of NAC systems. Each of switch 146A and router 147A within site 120A has an indirect connection to NAC system 180A via edge device 150A. In this example, switch 146A and router 147A may not support establishment of a secure connection directly with NAC system 180A, but edge device 150A may provide a proxy through which switch 146A and router 147A may connect to NAC system 180A. For example, each of switch 146A and router 147A have a direct connection 178A, to edge device 150A, and edge device 150A has a direct, secure connection 182A to NAC system 180A. Similarly, for site 102N, each of NAS devices 108N has an indirect connection to NAC system 180K via edge device 150N. In this example, APs 142N, switch 146N, and router 147N may not support establishment of a secure connection directly with NAC system 180K, but edge device 150N may provide a proxy through which NAS devices 108N may connect to NAC system 180K. For example, each of APs 142N, switch 146N, and router 147N have a direct connection 178N to edge device 150N, and edge device 150N has a direct, secure connection 182N to NAC system 180K.

Through secure connections 182, NAC systems 180 may receive network access requests from client devices 148 through NAS devices 108 (and in some cases edge devices 150) at nearby enterprise sites 102. In response to the network access requests, NAC systems 180 authenticate the requesting client devices using identity provider 115, such as an AAA server. NAC system 180 may perform fingerprinting to identify the authenticated client devices. NAC systems 180 then enforce the appropriate access policies on the identities of the authenticated client devices per the enterprise-specific configuration information 139 downloaded from NMS 130. In accordance with one specific implementation, a computing device is part of each of NAC systems 180. In accordance with other implementations, each of NAC systems 180A-180K may comprise one or more computing devices, dedicated servers, virtual machines, containers, services, or other forms of environments for performing the techniques described herein.

In accordance with one or more techniques of this disclosure, NAS device 108 may authenticate client devices 148 directly rather than requiring NAS device 108 to use NAC system 180 to authenticate client devices 148. For certificate authentication, NMS 130 may send NAS device 108 the server certificates and keys of NAC system 180 as well as a list of certification authorities (CA) to validate client certificates. NAS device 108 may then authenticate client devices 148 as proxy for NAC system 180. NAS device 108 may implement an Extensible Authentication Protocol (EAP) stack as an authentication framework. NAS device 108 will typically be associated with relatively few client devices and not all of the associated client devices will authenticate at the same time, so the authentication functionality will not be a significant computing overhead on NAS device 108.

NAC system 180 may also do a CRL check to determine if the certificate for client device 148 is revoked. Edge device 150 may also implement CRL check functionality for NAS device 108. Having CRL checking functionality outside of NAS device 108 lowers the computational burden on NAS device 108.

For password authentication, NAS device 108 may cache username and password hash pairs locally and then authenticate client device 148 using the password. NAS device 108 may check to ensure that the correct username and password pair is provided by client device 148. NAS device 108 may securely store passwords using a hash process that converts passwords into a hash value using a hashing algorithm.

NAC system 180 may maintain access policies for client devices 148. Access policies may allow levels of access privileges to networks including wireless networks, virtual local area networks (VLANs) and resources such as those defined by access control lists (ACLs). NAS device 108 may cache the last policy action for client device 148. If NAC system 180 is unavailable, NAS device 108 may use the cached policy action for the client device 148. NAS device 108 may distribute the cached policy actions to neighboring NAS devices so that the neighboring NAS devices may also use the cached policy actions during authorization.

For an incoming request from client device 148 and if a policy action is already in the cache, NAS device 108 may authorize the client device 148 to access wireless network 106 in accordance with the cached policy action and send a policy request to NAC system 180. If the policy response from NAC system 180 is different from the cached policy, NAS device 108 may initiate a Change of Authorization (CoA) to retrigger authentication. Since policies are not frequently modified, NAS device 108 may receive a policy response that often matches the policy response provided by NAC system 180. When NAC system 180 is unavailable and when NAS device 108 determines that client device 148 is not in the cache, NAS device 108 may give the client device 148 a default policy which may provide greater access than just guest access or a fallback internet access since NAS device 108 has authenticated client device 148.

Edge device 150 may implement a version of policy checking to evaluate certain policies when NAC system 180 is unavailable. Edge device 150 may thus provide some policy checking functionality when NAC system 180 is unavailable. NMS 130 may provision edge device 150 with policy configuration data. When NAC system 180 is unavailable, NAS device 108 may then check with edge device 150 for policy actions for client device 148. Edge device 150 may do policy evaluation to reduce latency even when NAC system is available since edge device 150 may store policy configuration data. Edge device 150 may send policy requests to NAC system for complex rules. In an example, edge device 150 may send a policy request that includes a CRL check with thousands of entries to one or more of NAC systems 180.

NAC system 180 may invalidate entries in the policy cache of NAS device 108. NAC system 180 may send a CoA request to NMS 130 for client devices 148. NMS 130 relays the CoA request to the relevant NAS device along with a message (such as a vendor specific attribute (VSA)) to clear the policy cache of entries for client device 148. NAS device 108 may then invalidate the entry in the policy cache and disconnect client device 148 to force a re-authentication.

The techniques of this disclosure provide one or more technical advantages and practical applications. NAC system 180 that interacts with NAS devices 108 that use policy caches may offer one or more advantages over traditional NAC solutions including centralized access policy management, resilience, reduced latency, and reduced cloud utilization. Rather than storing access policies on on-premises devices, NAC systems 180 may store them in the cloud, enabling centralized updating, management, and storage of these policies. Even if NAC system 180 becomes unavailable, a policy cache at NAS devices 108 may ensures continued access to the policies maintained by NAC system 180. The policy cache located on the NAS device 108 reduces latency in obtaining policy decisions, as it is local to the site instead of being remote like NAC system 180. Furthermore, NAS devices 108 that support certificate authentication may decrease cloud utilization and associated costs for NAC system 180 compared to NAS devices 108 that rely on NAC system 180 for certificate authentication.

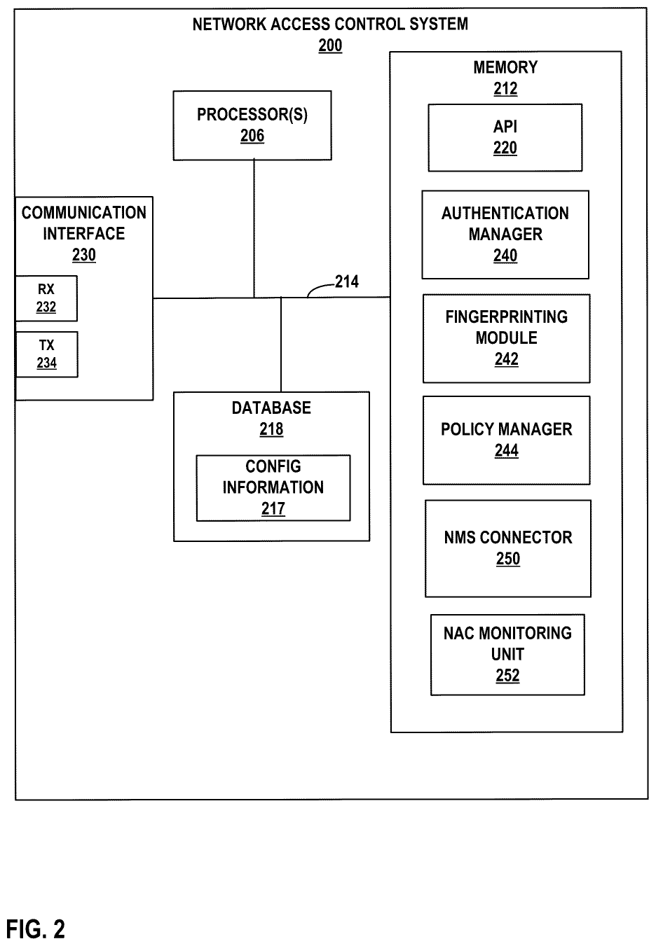

FIG. 2 is a block diagram of an example network access control (NAC) system 200, in accordance with one or more techniques of the disclosure. NAC system 200 may implement, for example, any of NAC systems 180 in FIGS. 1A, 1B. In such examples, NAC system 200 is responsible for authenticating and authorizing one or more client devices 148 to access wireless networks 106 at a sub-set of nearby enterprise sites 102A-102N. For the purposes of clarity, FIG. 2 will be discussed in the context one or more components of FIGS. 1A-1B.

NAC system 200 includes a communications interface 230, one or more processor(s) 206, a memory 212, and a database 218. The various elements are coupled together via a bus 214 over which the various elements may exchange data and information. In some examples, NAC system 200 receives network access requests from one or more of client devices 148 through NAS devices 108 (and in some cases edge devices 150) at the sub-set of nearby enterprise sites 102 from FIGS. 1A, 1B. In response to the network access requests, NAC system 200 authenticates the requesting client devices. In some examples, NAC system 200 enforces appropriate access policies on the authenticated client devices in accordance with enterprise-specific configuration information 217 downloaded from NMS 130 from FIGS. 1A, 1B. In some examples, NAC system 200 may be part of another server shown in FIGS. 1A, 1B or a part of any other server.

Processor(s) 206 execute software instructions, such as those used to define a software or computer program, stored to a computer-readable storage medium (such as memory 212), such as non-transitory computer-readable mediums including a storage device (e.g., a disk drive, or an optical drive) or a memory (such as Flash memory or RAM) or any other type of volatile or non-volatile memory, that stores instructions to cause the one or more processors 306 to perform the techniques described herein. Processor(s) 206 may be, may be part of, and/or may include processing circuitry that performs operations in accordance with one or more aspects of the present disclosure.

Communications interface 230 may include, for example, an Ethernet interface. Communications interface 230 couples NAC system 200 to a network and/or the Internet, such as any of network 134 as shown in FIG. 1A and/or any local area networks. Communications interface 230 includes a receiver 232 and a transmitter 234 by which NAC system 200 receives/transmits data and information to/from any of APs 142, switches 146, routers 147, edge devices 150, NMS 130, or servers 116, 122, 128 and/or any other network nodes, devices, or systems forming part of network system 100 such as shown in FIGS. 1A, 1B.

The data and information received by NAC system 200 may include, for example, configuration information 217 associated with one or more of enterprise sites 102 that is downloaded from NMS 130. Configuration information 217 may include enterprise-specific NAC configuration information, including access policies and associated policy assignment criteria. For example, configuration information 217 may define certain virtual local area networks (VLANs), access control lists (ACLs), registration portals, or the like, associated with certain categories of client devices. Configuration information 217 may further define, for each of the different categories of the client devices, different types of tracking, different types of authorization, and/or different levels of access privileges. In addition, the data and information received by NAC system 200 may include identification information of client devices 148 from NAS devices 108 that is used by NAC system 200 to perform fingerprinting of the end user devices in order to enforce the access policies as defined in configuration information 217. NAC system 200 may further transmit data and information via communications interface 330 to NMS 130 including, for example, NAC event data, which may be used by NMS 130 to remotely monitor the performance of NAC system 200.

Memory 212 includes one or more devices configured to store programming modules and/or data associated with operation of NAC system 200. For example, memory 212 may include a computer-readable storage medium, such as a non-transitory computer-readable medium including a storage device (e.g., a disk drive, or an optical drive) or a memory (such as Flash memory or RAM) or any other type of volatile or non-volatile memory, that stores instructions to cause the one or more processor(s) 206 to perform the techniques described herein.

In this example, memory 212 includes an API 220, an authentication manager 240, a fingerprinting module 242, a policy manager 244, NMS connector 250, and a NAC monitoring unit 252. NAC system 200 may also include any other programmed modules, software engines and/or interfaces configured for authentication and authorization of client devices 148.

As discussed elsewhere in this disclosure, NAS device 108 may authenticate client devices 148, but authentication manager 240 may do CRL checking. Authentication manager 240 may also implement authentication for NAS devices without authentication functionality. Authentication manager 240 enables authentication of client devices 148 at NAS devices 108 to access wireless networks 106, such as branch or campus enterprise networks, at the sub-set of enterprise sites 102 in communication with NAC system 200. Authentication manager 240 may perform the functionality of an AAA server, e.g., a RADIUS server, or provide access to an AAA server to authenticate client devices 148 (potentially using identity provider 115) prior to providing access to the wireless networks 106 via NAS devices 108. In some examples, authentication manager 240 may participate in a handshake exchange between a client device, an NAS device, and NAC system 200 controlling access at the NAS device. In other examples, authentication manager 240 may enable certificate-based authentication of client devices or enable interaction with cloud directory services to authenticate the client devices.

Fingerprinting module 242 enables identification of client devices 148 used to provide the client devices with appropriate authorizations or access policies based on their identities or categorizations. Fingerprinting module 242 may identify client devices 148 by analyzing network behavior of the client devices. Fingerprinting module 242 may receive the network behavior data of the client devices from NAS devices 108 and/or edge devices 150 in communication with NAC system 200. For example, fingerprinting module 242 may perform fingerprinting of client devices 148 based on one or more of MAC addresses, DHCP options used to request IP addresses, LLDP packets, user agent information, and/or device type and operating system information.

Policy manager 244 enables enforcement of the authorizations or access policies based on the identities or categorizations of the authenticated client devices. For example, policy manager 244 may assign the authenticated client devices to certain VLANs, apply certain ACLs, direct the client devices to certain registration portals, or the like, that are each associated with different types of tracking, different types of authorization, and/or different levels of access privileges in accordance with configuration information 217 for the corresponding enterprise of the client devices. In some examples, after a client device gains access to the enterprise network, policy manger 244 may monitor activities of the client device to identify security concerns and, in response, re-assign the client device to a quarantine VLAN or another less privileged VLAN to restrict access of the client device.

NMS connector 250 manages the data and information exchanged between NAC system 200 and NMS 130, e.g., via a RadSec tunnel or another encrypted tunnel 184, as shown in FIG. 1B. NMS connector 250 may maintain a log or mapping of which enterprise networks are served by NAC system 200 and the corresponding configuration information 217 for those enterprises. NMS connector 250 may also manage any updates or modifications to configuration information 217 received from NMS 130.

In accordance with one or more techniques of this disclosure, policy manager 244 may use policies stored in configuration information 217 to determine policy actions for client devices 148. Policy manager 244 may respond to policy requests from NAS device 108 for client devices 148 with a current policy action for client devices 148. NAS device 108 may then update policy cache with the current policy action for client device 148.

As discussed above, NAS device 108 may authenticate client devices 148. However, authentication manager 240 may do certain authentication functionality, such as CRL checking, not done by NAS device 108. Some authentication functionality such as CRL checking could potentially use too much of the resources (e.g., CPU utilization and/or communication bandwidth utilization) for NAS device 108. Authentication manager 240 may maintain the CRL list and, when NAC system 200 receives an authentication or other request for a client device that is on the CRL list, NAC system 200 may instruct NAS device 108 of the certificate revocation. NAS device 108 may then de-authenticate the client device.

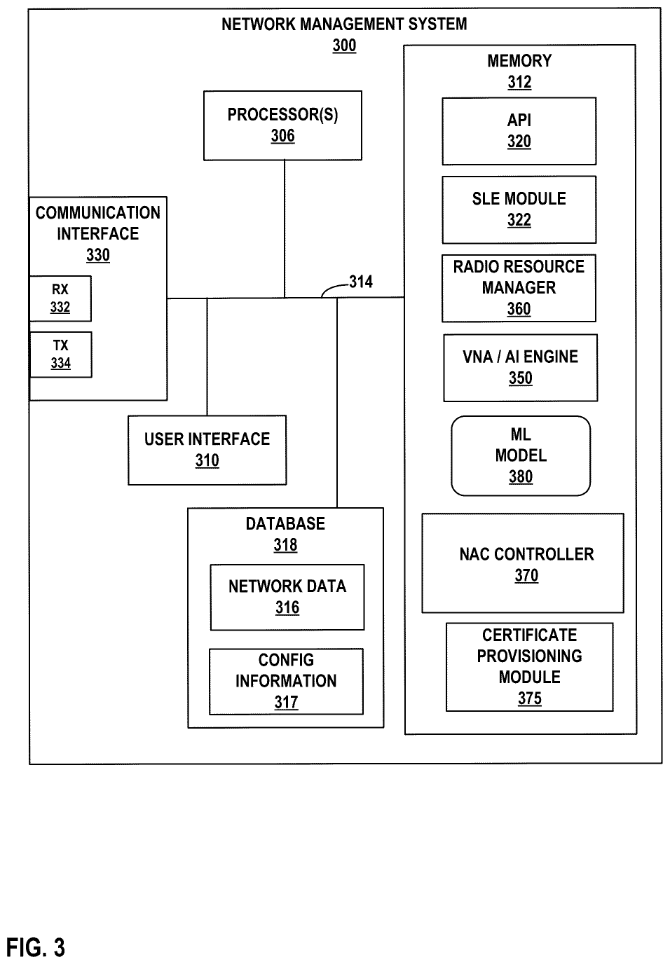

FIG. 3 is a block diagram of an example network management system (NMS) 300, in accordance with one or more techniques of the disclosure. NMS 300 may implement, for example, NMS 130 in FIGS. 1A, 1B. In such examples, NMS 300 is responsible for monitoring and management of one or more wireless networks 106A-106N at sites 102A-102N, respectively. For the purposes of clarity, FIG. 3 is discussed in the context of one or more components of FIGS. 1A-1B.

NMS 300 includes a communications interface 330, one or more processor(s) 306, a user interface 310, a memory 312, and a database 318. The various elements are coupled together via a bus 314 over which the various elements may exchange data and information. In some examples, NMS 300 receives data from one or more of client devices 148, APs 142, switches 146, routers, 147, edge devices 150, NAC systems 180, and other network nodes within network 134, e.g., routers and gateway devices, which may calculate one or more SLE metrics and/or update network data 316 in database 318. NMS 300 analyzes this data for cloud-based management of wireless networks 106A-106N. In some examples, NMS 300 may be part of another server shown in FIG. 1A or a part of any other server.

Processor(s) 306 execute software instructions, such as those used to define a software or computer program, stored to a computer-readable storage medium (such as memory 312), such as non-transitory computer-readable mediums including a storage device (e.g., a disk drive, or an optical drive) or a memory (such as Flash memory or RAM) or any other type of volatile or non-volatile memory, that stores instructions to cause the one or more processors 306 to perform the techniques described herein. Processor(s) 306 may be, may be part of, and/or may include processing circuitry that performs operations in accordance with one or more aspects of the present disclosure.

Communications interface 330 may include, for example, an Ethernet interface. Communications interface 330 couples NMS 300 to a network and/or the Internet, such as any of network(s) 134 as shown in FIG. 1A, and/or any local area networks. Communications interface 330 includes a receiver 332 and a transmitter 334 by which NMS 300 receives/transmits data and information to/from any of client devices 148, APs 142, switches 146, routers 147, edge devices 150, NAC systems 180, servers 116, 122, 128 and/or any other network nodes, devices, or systems forming part of network system 100 such as shown in FIG. 1A. In some scenarios described herein in which network system 100 includes “third-party” network devices that are owned and/or associated with different entities than NMS 300, NMS 300 does not directly receive, collect, or otherwise have access to network data from the third-party network devices. In some examples, an edge device, such as edge devices 150 from FIGS. 1A, 1B, may provide a proxy through which the network data of the third-party network devices may be reported to NMS 300.

The data and information received by NMS 300 may include, for example, telemetry data, SLE-related data, or event data received from one or more of client devices 148, APs 142, switches 146, routers 147, edge devices 150, NAC systems 180, or other network nodes, e.g., routers and gateway devices, used by NMS 300 to remotely monitor the performance of wireless networks 106A-106N and application sessions from client device to cloud-based application server. NMS 300 may further transmit data via communications interface 330 to any of the network devices, such as client devices 148, APs 142, switches 146, routers 147, edge devices 150, NAC systems 180, or other network nodes within network 134, to remotely manage wireless networks 106A-106N and portions of the wired network.

Memory 312 includes one or more devices configured to store programming modules and/or data associated with operation of NMS 300. For example, memory 312 may include a computer-readable storage medium, such as a non-transitory computer-readable medium including a storage device (e.g., a disk drive, or an optical drive) or a memory (such as Flash memory or RAM) or any other type of volatile or non-volatile memory, that stores instructions to cause the one or more processor(s) 306 to perform the techniques described herein.

In this example, memory 312 includes an API 320, an SLE module 322, a virtual network assistant (VNA)/AI engine 350, a radio resource management (RRM) engine 360, and a NAC controller 370. NMS 300 may also include any other programmed modules, software engines and/or interfaces configured for remote monitoring and management of wireless networks 106A-106N and portions of the wired network, including remote monitoring and management of any of APs 142, switches 146, routers 147, edge devices 150, NAC systems 180, or other network devices, e.g., routers and gateway devices.

SLE module 322 enables set up and tracking of thresholds for SLE metrics for each network 106A-106N. SLE module 322 further analyzes SLE-related data collected by, e.g., APs, such as any of APs 142 from client devices in each wireless network 106A-106N. For example, APs 142A-1 through 142A-N collect SLE-related data from client devices 148A-1 through 148A-N currently connected to wireless network 106A. This data is transmitted to NMS 300, which executes by SLE module 322 to determine one or more SLE metrics for each client device 148A-1 through 148A-N currently connected to wireless network 106A. This data, in addition to any network data collected by one or more APs 142A-1 through 142A-N in wireless network 106A, is transmitted to NMS 300 and stored as, for example, network data 316 in database 318.

RRM engine 360 monitors one or more metrics for each site 102A-102N in order to learn and optimize the RF environment at each site. For example, RRM engine 360 may monitor the coverage and capacity SLE metrics for a wireless network 106 at a site 102 in order to identify potential issues with SLE coverage and/or capacity in the wireless network 106 and to make adjustments to the radio settings of the access points at each site to address the identified issues. For example, RRM engine may determine channel and transmit power distribution across all APs 142 in each network 106A-106N. For example, RRM engine 360 may monitor events, power, channel, bandwidth, and number of clients connected to each AP. RRM engine 360 may further automatically change or update configurations of one or more APs 142 at a site 102 with an aim to improve the coverage and capacity SLE metrics and thus to provide an improved wireless experience for the user.

VNA/AI engine 350 analyzes data received from network devices as well as its own data to identify when undesired to abnormal states are encountered at one of the network devices. For example, VNA/AI engine 350 may identify the root cause of any undesired or abnormal states, e.g., any poor SLE metric(s) indicative of connected issues at one or more network devices. In addition, VNA/AI engine 350 may automatically invoke one or more corrective actions intended to address the identified root cause(s) of one or more poor SLE metrics. In some examples, ML model 380 may comprise a supervised ML model that is trained, using training data comprising pre-collected, labeled network data received from the network devices. The supervised ML model may comprise one of a logistical regression, naïve Bayesian, support vector machine (SVM), or the like. In other examples, ML model 380 may comprise an unsupervised ML model. Although not shown in FIG. 3, in some examples, database 318 may store the training data and VNA/AI engine 350 or a dedicated training module may be configured to train ML model 380 based on the training data to determine appropriate weights across the one or more features of the training data.

Examples of corrective actions that may be automatically invoked by VNA/AI engine 350 may include, but are not limited to, invoking RRM 360 to reboot one or more APs, adjusting/modifying the transmit power of a specific radio in a specific AP, adding SSID configuration to a specific AP, changing channels on an AP or a set of APs, etc. The corrective actions may further include restarting a switch and/or a router, invoking downloading of new software to an AP, switch, or router, etc. These corrective actions are given for example purposes only, and the disclosure is not limited in this respect. If automatic corrective actions are not available or do not adequately resolve the root cause, VNA/AI engine 350 may proactively provide a notification including recommended corrective actions to be taken by IT personnel, e.g., a site or network administrator using admin device 111, to address the network error.

NAC controller 370 implements a NAC configuration platform that provides user interface 310 for display to an enterprise network administrator, e.g., via admin device 111 of FIG. 1A, through which to receive access policy information for the enterprise network. NAC controller 370 creates enterprise-specific configuration information 317 stored in database 318 based on the input received via user interface 310. Configuration information 317 may include NAC configuration information for one or more enterprise networks managed by NMS 300. For each enterprise, configuration information 317 may including access policies and associated policy assignment criteria. For example, configuration information 317 may define certain VLANs, ACLs, registration portals, or the like, associated with certain categories of client devices, and may further define, for each of the different categories of the client devices, different types of tracking, different types of authorization, and/or different levels of access privileges. Configuration information 317 may be substantially similar to configuration information 139 of FIG. 1B.

NAC controller 370 manages the data and information exchanged between NMS 300 and NAC systems 180, e.g., via RadSec tunnels or another encrypted tunnels 184, as shown in FIG. 1B. NAC controller 370 may maintain a log or mapping of which enterprise networks are served by which of NAC systems 180 and the corresponding configuration information 317 for those enterprises. NAC controller 370 may also manage any updates or modifications to configuration information 317 to be pushed down to NAC systems 180. In addition, NAC controller 370 may monitor NAC systems 180 to identify failures of primary NAC systems and manage failovers to standby NAC systems.

In accordance with one or more techniques of this disclosure, certificate provisioning module 375 may provision NAS devices 108 with the server certificate of the NAC system 180 and a list of client certificates of the client devices 148. NMS 300 may store the server certificates of NAC systems 180 used by NAS devices as well as the client certificates of client devices 148. Certificate provisioning module 375 may create the list of relevant client certificates for each NAS device 108 based on data obtained while monitoring of the networks, client devices 148 and NAS devices 108. When a client device that is not in the list of client certificates contacts a provisioned NAS device 108, NAS device 108 may request a client certificate from NMS 300, such as through NAC system 180.

Although the techniques of the present disclosure are described in this example as performed by NMS 300, techniques described herein may be performed by any other computing device(s), system(s), and/or server(s), and that the disclosure is not limited in this respect. For example, one or more computing device(s) configured to execute the functionality of the techniques of this disclosure may reside in a dedicated server or be included in any other server in addition to or other than NMS 300, or may be distributed throughout network 100, and may or may not form a part of NMS 300.

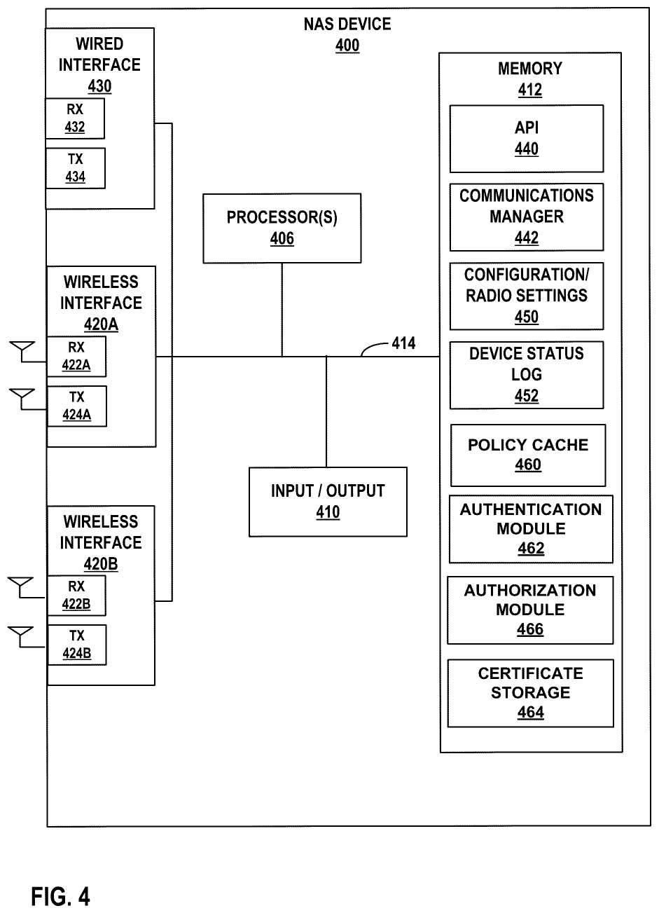

FIG. 4 is a block diagram of an example network access server (NAS) device 400, in accordance with one or more techniques of this disclosure. Example NAS device 400 shown in FIG. 4 may be used to implement any of NAS devices 108 as shown and described herein with respect to FIG. 1A such as access points 142, switches 146, and routers 147. The description below includes wireless functionality but NAS device 400 may be a wired device as well.

In the example of FIG. 4, NAS device 400 includes a wired interface 430, wireless interfaces 420A-420B one or more processor(s) 406, memory 412, and input/output 410, coupled together via a bus 414 over which the various elements may exchange data and information. Wired interface 430 represents a physical network interface and includes a receiver 432 and a transmitter 434 for sending and receiving network communications, e.g., packets. Wired interface 430 couples, either directly or indirectly, NAS device 400 to a wired network device, such as one of switches 146 or routers 147 of FIGS. 1A, 1, within the wired network via a cable, such as an Ethernet cable.

First and second wireless interfaces 420A and 420B represent wireless network interfaces and include receivers 422A and 422B, respectively, each including a receive antenna via which NAS device 400 may receive wireless signals from wireless communications devices, such as client devices 148 of FIGS. 1A, 1B. First and second wireless interfaces 420A and 420B further include transmitters 424A and 424B, respectively, each including transmit antennas via which NAS device 400 may transmit wireless signals to wireless communications devices, such as client devices 148 of FIGS. 1A, 1B. In some examples, first wireless interface 420A may include a Wi-Fi 802.11 interface (e.g., 2.4 GHz and/or 5 GHz) and second wireless interface 420B may include a Bluetooth interface and/or a Bluetooth Low Energy (BLE) interface. As described above, NAS device 400 may request network access for one or more client devices 148 from a nearby NAC system, e.g., NAC system 180 of FIG. 2 or one of NAC systems 180 of FIGS. 1A, 1B.

Processor(s) 406 are programmable hardware-based processors configured to execute software instructions, such as those used to define a software or computer program, stored to a computer-readable storage medium (such as memory 412), such as non-transitory computer-readable mediums including a storage device (e.g., a disk drive, or an optical drive) or a memory (such as Flash memory or RAM) or any other type of volatile or non-volatile memory, that stores instructions to cause the one or more processors 406 to perform the techniques described herein. Processor(s) 406 may be, may be part of, and/or may include processing circuitry that performs operations in accordance with one or more aspects of the present disclosure.

Memory 412 includes one or more devices configured to store programming modules and/or data associated with operation of NAS device 400. For example, memory 412 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause the one or more processor(s) 406 to perform the techniques described herein.

In this example, memory 412 stores executable software including an application programming interface (API) 440, a communications manager 442, configuration settings 450, a device status log 452, policy cache 460, authentication module 462, authorization module 466 and certificate storage 464. Device status log 452 includes a list of events specific to NAS device 400. The events may include a log of both normal events and error events such as, for example, memory status, reboot or restart events, crash events, cloud disconnect with self-recovery events, low link speed or link speed flapping events, Ethernet port status, Ethernet interface packet errors, upgrade failure events, firmware upgrade events, configuration changes, etc., as well as a time and date stamp for each event.

Input/output (I/O) 410 represents physical hardware components that enable interaction with a user, such as buttons, a display, and the like. Although not shown, memory 412 typically stores executable software for controlling a user interface with respect to input received via I/O 410. Communications manager 442 includes program code that, when executed by processor(s) 406, allow NAS device 400 to communicate with client devices 148 and/or network(s) 134 via any of interface(s) 430 and/or 420A-420C. Configuration settings 450 include any device settings for NAS device 400 such as radio settings for each of wireless interface(s) 420A-420C. These settings may be configured manually or may be remotely monitored and managed by NMS 130 to optimize wireless network performance on a periodic (e.g., hourly or daily) basis.

As described herein, NAS device 400 may measure and report network data from status log 452 to NMS 130. The network data may comprise event data, telemetry data, and/or other SLE-related data. The network data may include various parameters indicative of the performance and/or status of the wireless network. The parameters may be measured and/or determined by one or more of the client devices and/or by one or more of the APs in a wireless network. NMS 130/300 may determine one or more SLE metrics based on the SLE-related data received from the APs in the wireless network and store the SLE metrics as network data 137 (FIG. 1).

In accordance with one or more techniques of this disclosure, NAS device 400 may comprise a memory 412 including policy cache 460 having entries for one or more client devices where each entry includes a last policy action previously identified by NAC system 180 for the respective client device. NAS device 400 includes authentication module 462 that, upon receipt of an access request for the wireless network from a client device.

Authentication module 462 may enable certificate-based authentication of client devices 148. When NAS device 400 receives an access request for the wireless network from a client device 148, NAS device 400 may authenticate client device 148 to access wireless networks 106 based on an exchange of authentication certificates associated with NAC system 180 and client device 148. The authentication may be sufficient to indicate that the client device is a known device (for example, the NAS device 400 may assume that the authenticated client device is a company or employee device) and thus NAS device 400 may give the client device a default policy access that may be greater than a mere guest access to the wireless network when NAC system 180 is unavailable.

NAS device 400 may store a server certificate of NAC system 180 and a list of client certificates of client devices certificates in certificate storage 464. Authentication module 462 may send to client device 148, the server certificate of the NAC system. Based on validation of the server certificate by client device 148, authentication module 462 may receive from client device 148, a client certificate of the client device. Authentication module 462 may validate the client certificate of the client device based on the stored list of client certificates.

Authentication module 462 may enable password authentication. Authentication module 462 may cache username and password hash pairs locally and then authenticate client device 148 using the password. Authentication module 462 may ensure that the correct username and password pair was provided by client device 148. Authentication module 462 may securely store passwords hashes, hash the received passwords and compare the hashed received password to the stored password hash.

After NAS device 400 authenticates client device 148, authorization module 466 may determine whether client device 148 is in policy cache 460. Based on the client device being in the policy cache 460, authorization module 466 may authorize client device 148 to access the wireless network in accordance with the last policy action for the client device in the policy cache 460.

Based on the client device 148 not being in policy cache 460 authorization module 466 may send to NAC system 180, an access authorization request for the client device 148. NAC system 180 may then send, and NAS device 400 may receive, a current policy action identified for the client device based on one or more access policy rules for the wireless network maintained at NAC system 180. NAS device 400 may add an entry to policy cache 460 for the client device that includes the current policy action as the last policy action previously identified by the NAC system for client device 148. Policy cache 460 thus keeps the most recent policy action for client device 148.

When client device 148 is in policy cache 460 and NAC system 180 is available, authorization module 466 may authorize client device 148 based on the access policy action in the policy cache. Authorization module 466 may then send to NAC system 180 an access authorization request for client device 148. NAS device 400 may then receive from NAC system 180, a current policy action identified for client device 148 based on one or more access policy rules for the wireless network maintained at NAC system 180. Authorization module 466 may compare the current policy action for the client device to the last policy action for client device 148. Authorization module 466 may, based on the current policy action being different than the last policy action, invalidate the entry in the policy cache for the client device to trigger re-authentication. NAS device 400 may update policy cache 460 with the current policy action from NAC system 180.

When NAC system 180 is unavailable (for example when a wide area network (WAN) link between NAS device 400 and NAC system 180 is down) authorization module 466 may, based on client device 148 not being in the policy cache, authorize the client device to access the wireless network in accordance with a default policy. Since authentication module 462 has authenticated client device 148, authorization module 466 may set the default policy at a level greater than a guest access level.

NAS device 400 may synchronize the policy cache 460 with policy caches of one or more other NAS devices at the site. NAS device 108 may maintain a list of neighbor NAS devices and inform the neighbor NAS devices whenever NAS device 400 modifies policy cache 460 so that the neighbor NAS devices may update their policy caches accordingly.

The techniques of this disclosure provide one or more technical advantages and practical applications. Policy cache 460 may allow NAS device 400 to provide access actions to client device 148 even when access to NAC system 180 is unavailable providing resilience and reduced latency for client devices 148. Policy cache 460 at NAS device 400 ensures consistent access to the policies maintained by NAC system 180. Policy cache 460 reduces latency in obtaining policy decisions since policy cache 460 is local to the site unlike NAC system 180. Further, authentication module 462 at NAS device 400 may significantly decrease cloud utilization and associated costs for NAC system 180 compared to NAS devices that rely on NAC system 180 for certificate authentication.

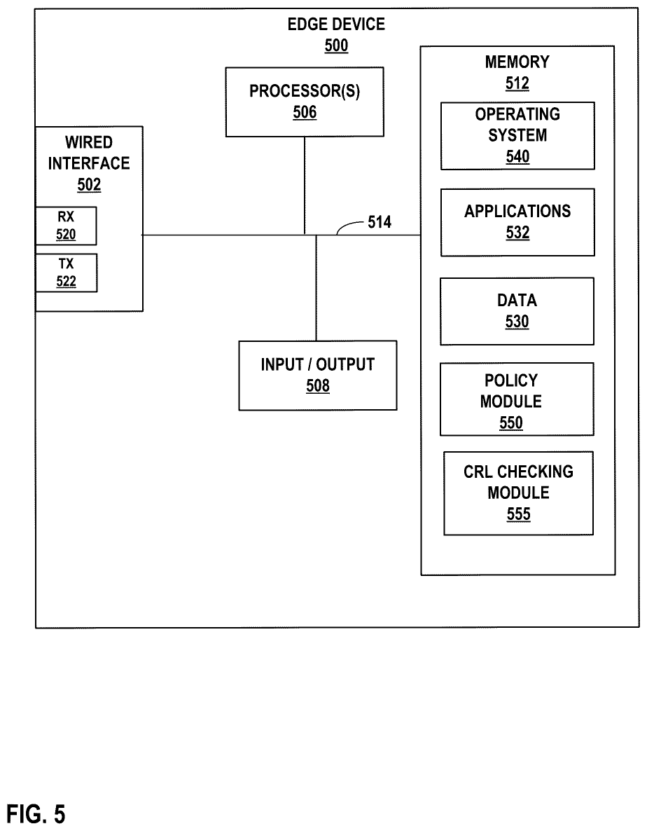

FIG. 5 is a block diagram illustrating an example edge device 500, in accordance with one or more techniques of this disclosure. Edge device 500 comprises a cloud-managed, wireless local area network (LAN) controller. Edge device 500 may implement, for example, any of edge devices 150 in FIGS. 1A, 1B. In such examples, edge device 500 comprises an on-premises device at a site 102 that is in communication with NMS 130 and one or more on-premises NAS devices 108, e.g., one or more APs 142, switches 146, or routers 147, from FIGS. 1A, 1B. Edge device 500 with NMS 130 and may operate to extend certain microservices from NMS 130 to the on-premises NAS devices 108 while using NMS 130 and its distributed software architecture for scalable and resilient operations, management, troubleshooting, and analytics.

In this example, edge device 500 includes a wired interface 502, e.g., an Ethernet interface, a processor 506, input/output 508, e.g., display, buttons, keyboard, keypad, touch screen, mouse, etc., and a memory 512 coupled together via a bus 514 over which the various elements may interchange data and information. Wired interface 502 couples edge device 500 to a network, such as network 134 shown in FIG. 1A and/or any local area networks. Wired interface 502 includes a receiver 520 and a transmitter 522 by which edge device 500 receives/transmits data and information to/from any of NAS devices 108 and NMS 130 and/or NAC systems 180. Though only one interface is shown by way of example, edge device 500 may have multiple communication interfaces and/or multiple communication interface ports.

Memory 512 stores executable software applications 532, operating system 540 and data/information 530. Data 530 may include a system log and/or an error log that stores event data, including behavior data, for edge device 500.

In accordance with one or more techniques of this disclosure, if an edge device 500 is at a site, CRL checking module 555 may maintain the CRL for client devices at a site. NAS devices 108 may check with edge device 500 during certificate authentication to see if a certificate for a client device has been revoked. Edge device 500 may receive the CRL list and updates to the CRL list from NAC system 180 or NMS 130.

Policy module 550 may also implement a version of policy checking to evaluate certain policies when NAC system 180 is unavailable. Policy Module 550 need not have full policy checking functionality but may provide additional policy checking functionality when NAC system 180 is unavailable. NMS 500 may provision edge device 500 with policy configuration data for policy module 550. When NAC system 180 is unavailable, NAS device 108 may check with edge device 150 for a policy action for client device 148.

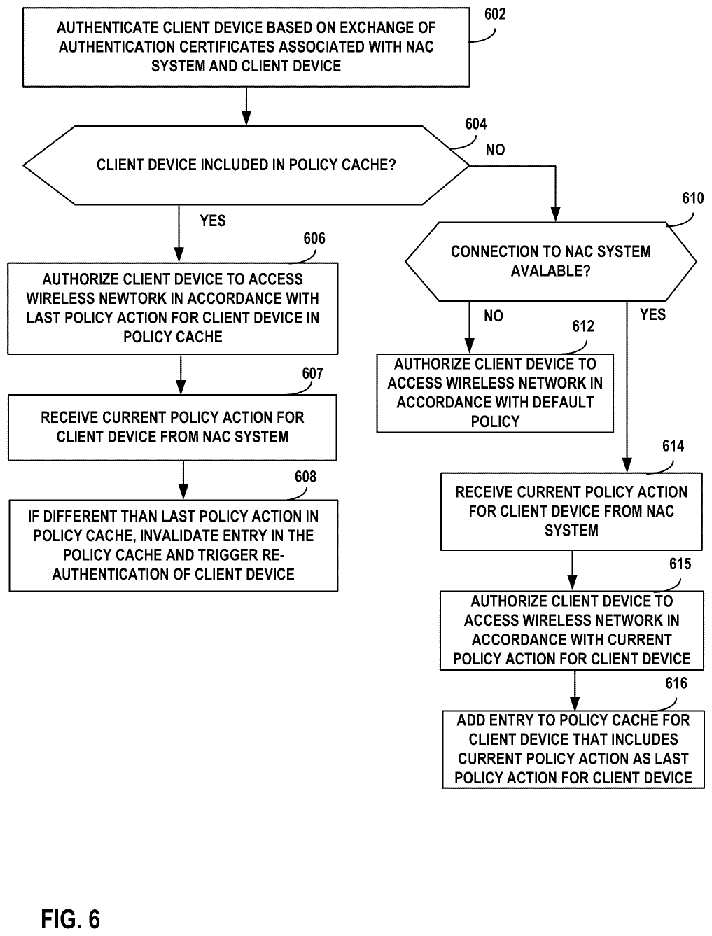

FIG. 6 is a flowchart illustrating an example policy access process, in accordance with one or more techniques of this disclosure. The example operation of FIG. 6 is described herein with respect to NAS device 108, client device 148, NAC systems 180, and other components of FIGS. 1A-B. In other examples, the operation of FIG. 6 may be performed by other computing systems or devices.

NAS device 108 authenticates client device 148 based on an exchange of authentication certificates associated with NAC system 108 and client device 148 (602). NAS device 108 may send a server certificate of NAC system 180 to client device 148. In some examples, NAS device 108 may send a server certificate received from NMS 130. Client device 148, based on receiving the server certificate, may validate the server certificate. NAS device 108 receives a client certificate from client device 148 after validate of the server certificate by client device 148. Based on the receipt of the client certificate from client device 148, NAS device 108 validates the client certificate of client device 148 based on a stored list of client certificates.

After authentication of client device 148, NAS device 108 may check whether the policy cache at NAS device 108 includes a policy action for client device 148 (604). If the policy cache at NAS device 108 includes the client device 148 (YES branch of 604), NAS device 108 authorizes client device 148 to access a wireless network, such as wireless network 106A, in accordance with the last policy action in the policy cache for the client device 148 (606). NAS device 108 receives a current policy action for client device 148 from one or more of NAC systems 180 (607). Based on receiving the current policy action, NAS system 108 may check with NAC systems 180 to obtain any updated policy action for client device 148. If the policy action obtained from NAC system 180 is different from the cached policy action from the policy cache, NAS device 108 invalidates the entry for the client device 148 in the policy cache and triggers re-authentication of client device 148 (608). NAS device 108 may provide an updated access response to client device 148 and update the policy cache at NAS device 108 to store the new policy action. If NAC system 180 is not immediately accessible, NAS device 108 may wait until NAC system 180 is available and allow the client device 148 access with the cached policy access.

If the policy cache at NAS device 108 does not include client device 148 (NO branch of 604), NAS device 108 may check if a connection to NAC system 180 is available (610). If a connection to NAC system 180 is not available (NO branch of 610), NAS device 108 may authorize client device 148 access to wireless network 106A in accordance with a default policy (612). If a connection to NAC system 180 is available (YES branch of 610), NAS device 108 may receive a current policy action for client device 148 from NAC system 180 (614). NAS device 108 may authorize client device 148 to access wireless network 106A according to the current policy action for client device 148 (615). NAS device 108 may then add an entry to the policy cache for client device 148 that includes the current policy action as the last policy action for client device 148 (616).

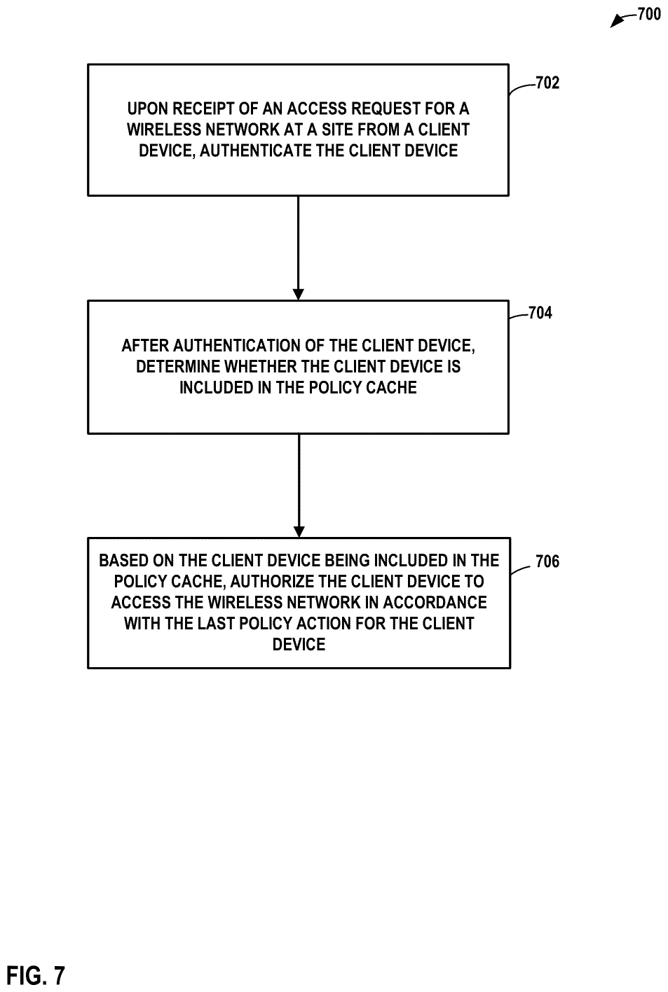

FIG. 7 is a flow chart illustrating an example operation 700 for the network access server policy cache, in accordance with one or more techniques of this disclosure. Example operation 700 of FIG. 7 is described herein with respect to NAS device 108, client device 148 and NAC systems 180 of FIGS. 1A-B. In other examples, operation 700 of FIG. 7 may be performed by other computing systems or devices.

NAS device 108, upon receipt of an access request for a wireless network such as a wireless network 106A at a site from a client device 148, may authenticate the client device 148 (702). For example, NAS device 108 may implement certificate based and/or password based authentication. Since NAS device 108 implements authentication, NAS device 108 may authenticate client device 148 even when NAC system 180 is unavailable.

After authentication of client device 148, NAS device 108 may determine whether client device 148 is in a policy cache at NAS device 108, the policy cache having entries for one or more client devices 148 where each entry includes a last policy action previously identified by NAC system 180 for the respective client device 148 (704).

Based on the client device 148 being in the policy cache, NAS device 108 may authorize client device 148 to access wireless network 106A in accordance with the last policy action for client device 148 (706). The policy cache allows for authorization when NAC system 180 is unavailable.

The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such as a processor or an integrated circuit device, such as an integrated circuit chip or chipset. Alternatively, or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as random-access memory (RAM), read-only memory (ROM), non-volatile random-access memory (NVRAM), electrically erasable programmable read-only memory (EEPROM), Flash memory, magnetic or optical data storage media, and the like. In some examples, an article of manufacture may comprise one or more computer-readable storage media.

In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

What is claimed is:

1. A network access server (NAS) device on a wireless network at a site, the NAS device comprising:
memory including a policy cache having entries for one or more client devices where each entry includes a last policy action previously identified by a network access control (NAC) system for the respective client device; and
processing circuitry configured to:
upon receipt of an access request for the wireless network from a client device, authenticate the client device;
after authentication of the client device, determine whether the client device is included in the policy cache; and
based on the client device being included in the policy cache, authorize the client device to access the wireless network in accordance with the last policy action for the client device.

2. The NAS device of claim 1, wherein the processing circuitry is configured to, based on the client device not being included in the policy cache:
send, to the NAC system, an access authorization request for the client device; and
receive, from the NAC system, a current policy action identified for the client device based on one or more access policy rules for the wireless network maintained at the NAC system.

3. The NAS device of claim 2, wherein the processing circuitry is configured to add an entry to the policy cache for the client device that includes the current policy action as the last policy action previously identified by the NAC system for the client device.

4. The NAS device of claim 1, wherein the processing circuitry is configured to, based on the client device being included in the policy cache:
send, to the NAC system, an access authorization request for the client device;
receive, from the NAC system, a current policy action identified for the client device based on one or more access policy rules for the wireless network maintained at the NAC system;
compare the current policy action for the client device to the last policy action for the client device; and
based on the current policy action being different than the last policy action, invalidate the entry in the policy cache for the client device to trigger re-authentication.

5. The NAS device of claim 1, wherein a wide area network (WAN) link between the NAS device and the NAC system is down, and wherein the processing circuitry is configured to, based on the client device not being included in the policy cache, authorize the client device to access the wireless network in accordance with a default policy.

6. The NAS device of claim 1, wherein the processing circuitry is configured to synchronize the policy cache with policy caches of one or more other NAS devices at the site.

7. The NAS device of claim 1, wherein the processing circuitry authenticates the client device based on an exchange of authentication certificates associated with the NAC system and the client device.

8. The NAS device of claim 7, wherein the memory is configured to store a server certificate of the NAC system and a list of client certificates of client devices, and wherein to authenticate the client device in response to receipt of the access request, the processing circuitry is configured to:
send, to the client device, the server certificate of the NAC system;
based on validation of the server certificate by the client device, receive, from the client device, a client certificate of the client device; and
validate the client certificate of the client device based on the stored list of client certificates.

9. The NAS device of claim 8, wherein the processing circuitry is configured to receive the server certificate of the NAC system and the list of client certificates of the client devices from a network management system (NMS) configured to manage a plurality of NAS devices across one or more sites and one or more NAC systems.

10. The NAS device of claim 1, wherein the processing circuitry authenticates the client device based on password authentication with the client device.

11. A system comprising:
a network access control (NAC) system in communication with a plurality of network access server (NAS) devices for wireless networks at one or more sites, the NAC system configured to maintain access policy rules for the wireless networks; and
a NAS device of the plurality of NAS devices for a wireless network at a site, the NAS device configured to:
upon receipt of an access request for the wireless network from a client device, authenticate the client device;
after authentication of the client device, determine whether the client device is included in a policy cache at the NAS device, the policy cache having entries for one or more client devices where each entry includes a last policy action previously identified by the NAC system for the respective client device; and
based on the client device being included in the policy cache, authorize the client device to access the wireless network in accordance with the last policy action for the client device.

12. The system of claim 11, wherein the NAS device is configured to, based on the client device not being included in the policy cache:
send, to the NAC system, an access authorization request for the client device; and
receive, from the NAC system, a current policy action identified for the client device based on one or more access policy rules for the wireless network maintained at the NAC system.

13. The system of claim 12, wherein the NAS device is configured to add an entry to the policy cache for the client device that includes the current policy action as the last policy action previously identified by the NAC system for the client device.

14. The system of claim 11, wherein the NAS device is configured to, based on the client device being included in the policy cache:
send, to the NAC system, an access authorization request for the client device;
receive, from the NAC system, a current policy action identified for the client device based on one or more access policy rules for the wireless network maintained at the NAC system;
compare the current policy action for the client device to the last policy action for the client device; and
based on the current policy action being different than the last policy action, invalidate the entry in the policy cache for the client device to trigger re-authentication.

15. The system of claim 11, wherein a wide area network (WAN) link between the NAS device and the NAC system is down, and wherein the NAS device is configured to, based on the client device not being included in the policy cache, authorize the client device to access the wireless network in accordance with a default policy.

16. The system of claim 11, wherein the NAS device is configured to synchronize the policy cache with policy caches of one or more other NAS devices at the site.

17. A method comprising:
upon receipt of an access request for a wireless network at a site from a client device, authenticating, by a network access server (NAS) device on the wireless network, the client device;
after authentication of the client device, determining, by the NAS device, whether the client device is included in a policy cache at the NAS device, the policy cache having entries for one or more client devices where each entry includes a last policy action previously identified by the NAC system for the respective client device; and
based on the client device being included in the policy cache, authorizing, by the NAS device, the client device to access the wireless network in accordance with the last policy action for the client device.

18. The method of claim 17, further comprising, based on the client device not being included in the policy cache:
sending, by the NAS device to the NAC system, an access authorization request for the client device; and
receiving, by the NAS device from the NAC system, a current policy action identified for the client device based on one or more access policy rules for the wireless network maintained at the NAC system.

19. The method of claim 18, further comprising adding an entry to the policy cache for the client device that includes the current policy action as the last policy action previously identified by the NAC system for the client device.

20. The method of claim 17, further comprising synchronizing the policy cache at the NAS device with policy caches of one or more other NAS devices at the site.
